(19) United States
(12) Patent Application Publication
(10) Pub. No.: US 2012/0092758 A1
(43) Pub. Date: Apr. 19, 2012

(54) NANOCOMPOSITES, METHOD FOR PRODUCING SAME, AND USE THEREOF IN DEVICES FOR PROTECTING AGAINST ELECTROMAGNETIC WAVES

(75) Inventors: Valerie Keller-Spitzer, Oberschaeffolsheim (FR); Anne Teissier, Saint Jean De Boiseau (FR); Yves Lutz, Hesingue (FR); Jean-Pierre Moeglin, Mulhouse (FR); Olivier Muller, Lautenbach (FR); Fabrice Lacroix, Saint-Louis (FR)

(73) Assignees: Institut Franco-Allemand De Recherche De Saint Louis, Saint Louis (FR); Centre National De La Recherche Scientifique - CNRS, Paris Cedex 16 (FR)

(21) Appl. No.: 13/201,596

(22) PCT Filed: Feb. 16, 2010
(86) PCT No.: PCT/FR2010/000128

§ 371 Date: Dec. 23, 2011

(30) Foreign Application Priority Data
Feb. 16, 2009 (FR) 09/00695

(51) Int. Cl. G02B 5/20; G02F 1/355; D01F 9/12; B82Y 40/00; B82Y 20/00

(52) U.S. Cl. 359/358; 252/587; 428/389; 428/367; 977/762; 977/750; 977/752; 977/932; 977/902; 977/896; 977/846; 977/847

(57) ABSTRACT

A nanocomposite, comprising single-wall and/or multi-wall one-dimensional nanomaterials, and at least one nanooxide of at least one transition metal, said nanooxide filling said nanotubes and covering their walls. A process for preparing such a nanocomposite and an optical limiting device comprising such a nanocomposite in suspension in a medium that is transparent to visible and infrared radiation are disclosed.

### TECHNICAL FIELD

The present invention relates in general to a nanocomposite comprising one-dimensional nanomaterials and to applications, especially for protecting against electromagnetic waves.

The present invention relates in particular to a particular nanocomposite, which comprises one-dimensional nanomaterials filled and/or covered with at least one nanooxide of at least one transition metal, to the method for preparing it, and to an optical limiting device comprising such a nanocomposite suspended in a medium which is transparent to visible and infrared radiation. Such an optical limiting device is highly advantageous for applications for protecting against electromagnetic waves ranging from the visible to the medium infrared range.

In the description below, the references in parentheses ([]) refer to the list of references presented after the examples.

### PRIOR ART

At the present time, the known protection systems based on nanoparticles in suspension cannot be used in the infrared band III.

Among these protection systems, mention may be made especially of systems formed from a suspension of carbon black. Such devices give good results in terms of protection against luminous fluxes with wavelengths ranging from the visible range to the near infrared, but their use poses many problems, and especially that of keeping the carbon particles in suspension. In addition, such systems are not at all suited to limitation in the infrared range (in particular the medium infrared) since water is a totally absorbent liquid and thus not transparent in the infrared.

Systems formed from filters also exist, which have the drawback of being wavelength-selective.

Systems based on organic pigments also exist, which are expensive materials, synthesized with solvents of substantial toxicity.

Finally, optical limiting devices for the visible or near infrared range also exist, comprising carbon nanotubes suspended in water or chloroform (French Patent FR 2 787 203 [1] or “Single-wall carbon nanotubes for optical limiting” by L. Vivien, E. Anglaret, D. Riehl, F. Bacou, C. Journet, C. Goze, M. Andrieux, M. Brunet, F. Lafonte, P. Bernier and F. Hache, in “Chemicals Physics Letters” 307 (1999), 317-319 [2], or “Optical limiting properties of single-wall carbon nanotubes” by L. Vivien, E. Anglaret, D. Riehl, F. Hache, F. Bacou, M. Andrieux, F. Lafonte, C. Journet, C. Goze, M. Brunet, and P. Bernier, from “Optical Communications” 174 (2000) 271-275 [3], or “Optical limiting properties of carbon nanotubes” in L. Vivien, D. Riehl, F. Hache, and E. Anglaret, in “Physical B” B 323 (2002) 233-234 [4]).

The devices described in patent [1] and the scientific publications [2] to [4] have the drawback of lacking stability in suspension, which limits their long-term use under real conditions of protection against an electromagnetic wave, unless they are functionalized by complex and expensive techniques.

There is thus a real need for a material that is stable in suspension in a medium that is transparent to visible and infrared radiation (for example chloroform), for producing an optical limiting device that overcomes the drawbacks of the prior art, and that can especially constitute a device for protecting against electro-magnetic waves ranging from the visible to the medium infrared range.

### DESCRIPTION OF THE INVENTION

The aim of the present invention is, precisely, to satisfy this need by providing a nanocomposite, characterized in that it comprises single-wall and/or multi-wall one-dimensional nanomaterials, and at least one nanooxide of at least one transition metal, said nanooxide filling said nanotubes and/or covering their walls.

Generally, a material is termed as one-dimensional when one of the dimensions is markedly larger (at least 10 times) than the other two.
For the purposes of the present invention, the term “one-dimensional nanomaterials” means:
   nanotubes with a morphology of tubular, hollow shape open at both ends, the diameter of which may range from a few nanometres (especially from 2 to 5 nm) to a few hundred nanometres (especially from 100 to 250 nm), or
   nanofibres of solid tubular morphology whose diameter may vary within the same range of dimensions as the nanotubes.

The term “one-dimensional nanomaterial” is used when these two smallest dimensions are on the nanometric scale (dimensions of between one and a few hundred nanometres, i.e. generally on the submicron scale).

The term “single-wall one-dimensional nanomaterials” means, in the present invention, nanomaterials formed from a single leaflet of atoms rolled up on itself.

The term “multi-wall one-dimensional nanomaterials” means, in the present invention, nanomaterials formed from several leaflets of atoms rolled up on themselves to form concentric cylinders (of Russian doll type) or rolled up in a spiral (of parchment type).

Advantageously, the one-dimensional nanomaterials may be formed from a heat-conducting and/or electrically conducting and/or ion-conducting material.

Advantageously, the one-dimensional nanomaterials are formed from carbon or from a transition metal oxide. However, they may also be formed from transition metal carbides, sulfides, nitrides or borides.

The one-dimensional nanomaterials that may be used to prepare a nanocomposite according to the invention may comprise, for example, carbon nanotubes (CNTs), carbon nanofibres, titanium oxide TiO₂ nanofibres and titanium oxide TiO₂ (or titanate) nanotubes. The transition metal nanooxides that may be used to prepare the nanocomposites according to the invention may comprise, for example, niobium pentoxide Nb₂O₅, titanium dioxide TiO₂, tungsten trioxide WO₃, iron oxide Fe₂O₃, vanadium oxide VO₂, zinc oxide ZnO or magnesium oxide MgO. A preferred nanooxide is niobium pentoxide Nb₂O₅.

The preferred nanocomposites that are according to the invention are the following:
carbon nanotubes (CNTs) comprising niobium pentoxide,
carbon nanotubes (CNTs) comprising titanium dioxide,
carbon nanofibres comprising niobium pentoxide,
titanium dioxide nanotubes comprising tungsten trioxide WO₃, and
titanium dioxide nanotubes comprising niobium pentoxide.

A subject of the present invention is also an optical limiting device comprising a nanocomposite according to the invention, which is suspended in a medium that is transparent to visible and infrared radiation. Such an optical limiting device constitutes an ideal device for protecting against electromagnetic waves with wavelengths ranging from the visible to the medium infrared range (medium IR: band III, 8-12 μm).

Advantageously, the medium that is transparent to visible and infrared radiation is a liquid medium, such as chloroform (CHCl₃) or carbon disulfide (CS₂).

Chloroform will preferably be used as dispersant, due to the stability of the suspension of nanocomposite in this medium. Furthermore, the toxicity of chloroform is much lower than that of carbon disulfide.

The optical limiting device according to the invention formed by a nanocomposite according to the invention in suspension in chloroform in fact leads to a system that has noteworthy non-linear properties if it is subjected to stimulation of laser aggression type. The use of such a device leads to optical limiting that is ideal for protecting a sensor.

To increase the stability of the suspension of nanocomposite according to the invention in the liquid medium that is transparent to visible and infrared radiation, said medium may comprise one or more surfactants or dispersants, such as polyvinyl acetate (PVA) or sodium dodecyl sulfate.

Besides the liquid media that are transparent to visible and infrared radiation, it is also possible to use as medium that is transparent to visible and infrared radiation a medium that is not liquid, for instance liquid crystals or solid thin films.

A subject of the present invention is also a process for preparing a nanocomposite according to the invention, characterized in that it comprises the following steps:

a) either a step of formation via the sol-gel route of a gel from a mixture:
of an alcoholic solution containing at least one alkoxide or a transition metal chloride, and
single-wall or multi-wall one-dimensional nanomaterials, said gel in formation being in amorphous form;

b) or a step of impregnating a salt containing at least one transition metal precursor;

c) optionally, a step of milling the gel obtained in step a); and

d) a step of calcination of said optionally milled gel obtained in step c) at a temperature and for a time of crystallization of the transition metal nanooxide inside the nanomaterials and/or on their walls, while conserving the one-dimensional nature of the nano-materials.

In step a) of formation of the amorphous gel, niobium ethoxide Nb(OEt)₅ is advantageously used as transition metal alkoxide in the process of the invention, when it is desired to produce nanocomposites comprising niobium pentoxide (in the present case carbon nanofibres or titanium dioxide nanotubes comprising niobium pentoxide) or titanium tetraisopropoxide Ti(OiPr)₄ when it is desired to prepare nanocomposites comprising titanium dioxide as nanooxides (in the present case carbon nanotubes comprising titanium dioxide).

In the impregnation step b), ammonium paratung-state (NH₄)₁₀W₁₂O₄₁ is advantageously used as salt when it is desired to prepare nanocomposites comprising tungsten trioxide (in the present case TiO₂ nanofibres or TiO₂ nanotubes or titanates comprising tungsten trioxide).

Advantageously, the process of the invention comprises, prior to the formation (a) of the amorphous gel or the impregnation (b), a step of ultrasonication treatment of the one-dimensional nanomaterials. This additional step makes it possible to depill (or more generally to deaggregate) the one-dimensional nanomaterials, which are generally in the form of bundles, in particular in the case of carbon nanotubes or TiO₂ (or titanate) nanotubes.

Advantageously, the process of the invention comprises, subsequent to the step of formation (a) of the amorphous gel or of impregnation (b), a step of heat treatment at a temperature that allows the excess alcohol or water to be removed.

Advantageously, in the process of the invention, the calcination temperature is between 150° C. and 550° C., as a function of the nature of the one-dimensional nanomaterials and nanooxides used. Thus, in the case of carbon nanotubes covered and/or filled with niobium pentoxide, the calcination temperature is between 450° C. and 530° C., and is preferably about 520° C. For TiO₂ nanotubes that are also covered and/or filled with niobium pentoxide, the calcination temperature is between 150° C. and 550° C., and preferably about 350° C.

Finally, a subject of the present invention is the use of an optical limiting device according to the invention for protecting an optical and/or optronic device against electromagnetic waves with wavelengths ranging from the visible to the medium infrared range (in particular in the infrared band III), and in particular an optical switch. Such a limiting device then plays the essential role of switch.

In fact an optical system not bearing a switch can be damaged when the optical flux is higher than the threshold for damaging the various components. In contrast, when the optical switch is incorporated into the optical line, it will clip the high fluxes, which will have the effect of protecting the optical components located downstream of the line. A good optical limiter will have rapid “switching” and a low switching threshold, which is reflected physically by high non-linearity.

Placing particles of the nanocomposite according to the invention in suspension in a solvent makes it possible to produce the switching function while limiting the transmission of the incident beam for high fluxes.

Other advantages may also emerge to those skilled in the art on reading the examples below, which are illustrated by the attached figures, given for illustrative purposes.

15

### BRIEF DESCRIPTION OF THE FIGURES

FIG. 1 is a flow diagram of the Z-SCAN method used for studying the non-linear behaviour of examples of nanocomposites according to the invention,

FIG. 2 is a flow diagram of the pump-probe method used for studying the switching rate of examples of nanocomposites according to the invention,

FIG. 3 is a high-resolution transmission electron microscopy (TEM) image of a first example of a nanocomposite according to the invention (Nb₂O₅, carbon nanotubes),

FIG. 4 is a high-resolution transmission electron microscopy (TEM) image of a second example of a nanocomposite according to the invention (TiO₂, carbon nanotubes),

FIG. 5 is a scanning electron microscopy (SEM) image of a third example of a nanocomposite according to the invention (Nb₂O₅, TiO₂ nanotubes) obtained with a calcination temperature of 450° C.,

FIG. 6 shows two high-resolution transmission electron microscopy (TEM) images (FIGS. 6A and 6B) of a fourth example of a nanocomposite according to the invention (WO₃, TiO₂ nanotubes),

FIG. 7 is a high-resolution transmission electron microscopy (TEM) image of a fifth example of a nanocomposite according to the invention (Nb₂O₅, carbon nanofibres),

FIG. 8 shows the comparative change as a function of time in size of the grains of the nanocomposite shown in FIG. 3 in suspension in chloroform with that of CNTs also in suspension in chloroform,

FIG. 9 shows, firstly, a photograph of the nanocomposite shown in FIG. 1 in suspension in chloroform (FIG. 9A) and, secondly, a photograph of CNTs also in suspension in chloroform (FIG. 9B),

FIG. 10 shows the comparative change in non-linear behaviour of the nanocomposite of FIG. 3 in suspension in chloroform, with that of chloroform, on the one hand, and that of CNTs, on the other hand, also in suspension in chloroform,

FIG. 11 shows a comparison of the switching rate, measured by the pump-probe device, of the Nb₂O₅/CNT nanocomposite according to the invention of FIG. 3 (FIG. 11A) with that of carbon nanotubes alone (FIG. 11B),

FIG. 12 shows the comparative change in non-linear behaviour of the nanocomposites of FIG. 5 in suspension in chloroform with that of TiO₂ nanotubes also in suspension in chloroform,

FIG. 13 shows the change in switching rate of the nanocomposites of FIG. 5 at different intervals after suspending them in chloroform.

### EXAMPLES

### Products Used for the Synthesis of the Nanocompo-Sites

absolute ethanol: FLUKA product sold by the company Sigma-Aldrich,

acetic acid: FLUKA product sold by the company Sigma-Aldrich,

multi-leaflet carbon nanotubes: sold by Pyrograf Products Inc. under the trade name Pyrograf®-III Carbon Nanotube,

niobium ethoxide (Nb(OEt)₅) at 99.95%: sold by the company Sigma-Aldrich under the trade name Niobium (V) ethoxide.

### Tests for Characterizing the Nanocomposites

### Study of the Non-Linear Behaviour via the Z-SCAN Method

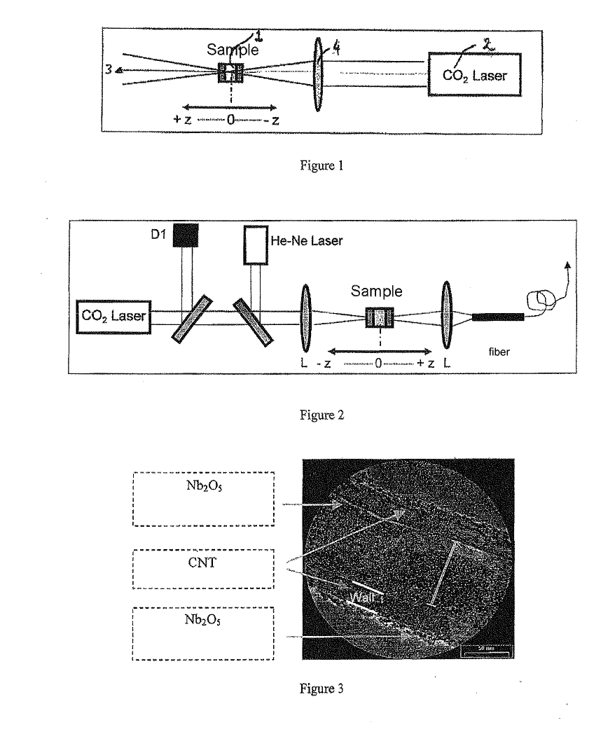

To study the non-linear behaviour of the examples of nanocomposites according to the invention, the Z-SCAN method is used, the operating principle of which is illustrated in FIG. 1.

The principle of this method is as follows:
a sample 1, formed from a cell comprising a nanocomposite in suspension in chloroform, is translated along the propagation axis 3 of a laser beam 2 (of CO₂ type) about the focal point of a convergent lens 4; when the sample 1 is in position 0, it is at the focal point of the lens 4,
the transmission of sample 1 about position 1 is evaluated by placing just behind sample 1 a detector (not shown in FIG. 1) to collect the transmitted energy.

If sample 1 has non-linear behaviour, the energy collected by the detector is minimal when the power density received by the sample is maximal, i.e. when the sample is placed at the focal point of the lens.

### Pump-Probe Method

To study the change in the switching rate of the examples of nanocomposites according to the invention, the pump-probe method is used, the operating principle of which is illustrated in FIG. 2.

This method makes it possible simultaneously to measure rapid phenomena such as a drop in transmission, and slow phenomena such as the relaxation of the system and the return to the initial state thereof.

It consists in superposing two laser beams of different wavelengths on the sample which are arranged as follows:
the probe is a helium-neon (He-Ne) laser emitting continuously at 633 nm through the sample, whose radiation does not modify the medium,
the pump is the pulsed CO₂ laser that generates the non-linearities in the medium. It acts as a perturber.
part of the pump beam is taken up by means of a separating plate and collected on a detector D1 and constitutes the reference signal (signal of FIG. 11).
the lenses L make it possible to focus the beams in the sample and at the fibre inlet.

A modification of the properties of the medium (via the formation of a thermal lens, by non-linear scattering) will have an effect on the trajectory of the probe beam.

The probe radiation is collected by an optical fibre connected to a photodiode. The transmission drop is visualized on an oscilloscope. To discern the various phenomena associated with different time regimes, it suffices to change the time basis of the oscilloscope.

### Example 1: Preparation of a Nanocomposite According to the Invention Formed from Carbon Nanotubes Covered and Filled with Niobium Pentoxide

A nanocomposite according to the invention based on commercial powders of multi-leaflet carbon nanotubes (CNTs) and niobium pentoxide (Nb₂O₅/CNT powders) is prepared via the sol-gel route.

The sol-gel method used in the context of the present invention is based on the hydrolysis and condensation of niobium alkoxides or chlorides in an alcoholic solution in acidic medium. This method, known as “mild chemistry” (on account of the absence of use of pollutant solvents and of harsh experimental conditions), makes it possible to obtain solid particles of nanometric size.

Depilling/Deaggregation of the Bundles of CNT tubes

20 ml of absolute ethanol are mixed with 20 ml of acetic acid (these products are used without additional purification). The carbon nanotubes are added to the mixture and ultrasonicated for one hour so as to depell the bundles of carbon nanotubes. The solution obtained is black.

### Formation of the Amorphous Gel (Step a) of the Process of the Invention

1 ml of niobium ethoxide is added to the preceding solution, and the mixture thus obtained is ultrasonicated for one hour. Next, the whole is diluted with 20 ml of ethanol and the mixture is then left in the open air (for maturation) all day and all night so as to allow the formation of a sol, the evaporation of the solvent and the formation of the gel. A “dry” gel is then obtained, which is placed in an oven for 15 hours at 110° C. to remove the excess solvent.

### Milling of the Gel (Step c) of the Process of the Invention

The gel obtained is milled manually in a mortar using a pestle, and a black powder is obtained.

### Calcination of the Milled Gel (Step d) of the Process of the Invention

After milling the gel, the powder obtained is placed in a calcination oven so as to obtain crystallization of the niobium pentoxide. The heat treatment that is performed therein is a calcination in air comprising a temperature increase ramp at 10° C/minute up to a temperature of 520° C. (increase over a period of about 50 minutes), and then maintenance at this temperature for 2 hours 45 minutes. At the end of calcination, a grey powder formed from carbon nanotubes covered and/or filled uniformly with niobium pentoxide nanoparticles is obtained.

The calcination temperature adopted is a compromise between a temperature that limits the degradation of the nanotubes and a temperature that allows excellent crystallization of the niobium pentoxide, which is about 550° C. Calcination in air performed at this temperature of 520° C. makes it possible to produce, from the starting materials such as commercial multi-leaflet carbon nanotubes and niobium ethoxide, a powder formed from carbon nanotubes that are slightly degraded in terms of one-dimensional morphology but which are covered and filled uniformly with niobium pentoxide nanoparticles. The whole is well crystallized.

The nanocomposite thus obtained is then characterized by laser granulometry (measurement of the size of the grains of the powder obtained in suspension) and by high-resolution transmission electron microscopy (morphology and structure of the nanotubes and of the nanooxides). Next, the following are studied via optical measurements:
the non-linear behaviour of this material by means of the Z-scan technique, and
its switching rate by pump-probe measurements.

### Example 2: Characterization of the Nanocomposite of Example 1, in Terms of Morphology and Particle Size

### Characterization of the Morphology and Structure by TEM

An image of the structure and morphology of the nanocomposite of Example 1 was obtained by high-resolution transmission electron microscopy (TEM).

This image presented in FIG. 3 shows that the nanocomposite of Example 1 is formed from carbon nanotubes filled and/or covered with niobium pentoxide.

### Characterization of the Size of the Grains by Laser Granulometry

The nanocomposite of Example 1 is suspended in chloroform at a rate of 2 g/l. The change as a function of time of the mean size of the particles or aggregates of the nanocomposite of Example 1 suspended in chloroform is then recorded by laser granulometry.

In parallel, the change as a function of time of the mean size of the carbon nanotubes suspended in chloroform (also at a rate of 0.2 g/l) after ultrasonication is also recorded.

The nanoparticle concentration of each suspension is adjusted so as to have identical linear transmissions (of nanocomposite according to the invention, on the one hand, and of carbon nanotubes, on the other hand). It is thus 2 g/l for the suspension containing the nanocomposite, and 0.2 g/l for the suspension containing the carbon nanotubes. This concentration adjustment is necessary for studying the non-linear behaviour of the suspensions.

The changes as a function of time of the mean size of the particles of the nanocomposite of Example 1 and of CNTs are presented in FIG. 8, which shows that the nanocomposite of Example 1 Nb₂O₅/CNTs is markedly more stable than the CNTs alone (not filled and not covered with niobium pentoxide), whether as regards the maintenance in suspension in chloroform, or as regards the maintenance of particles or aggregates of small size. This stability aspect is a deciding factor for the development and use of the nanocomposite of Example 1 in an optical limiting device.

This stability of the nanocomposite of Example 1 suspended in chloroform is observable with the naked eye, whereas the carbon nanotubes alone are particularly unstable, as shown in FIGS. 9A and 9B.

### Example 3: Study of the non-linear behaviour of the nanocomposite of Example 1 (via the Z-SCAN method)

For this study, the non-linear behaviour of the nanocomposite of Example 1 suspended in chloroform, that of chloroform (solvent) and that of CNTs suspended in chloroform were studied via the Z-scan technique. The concentrations are identical to those used in the particle size measurements.

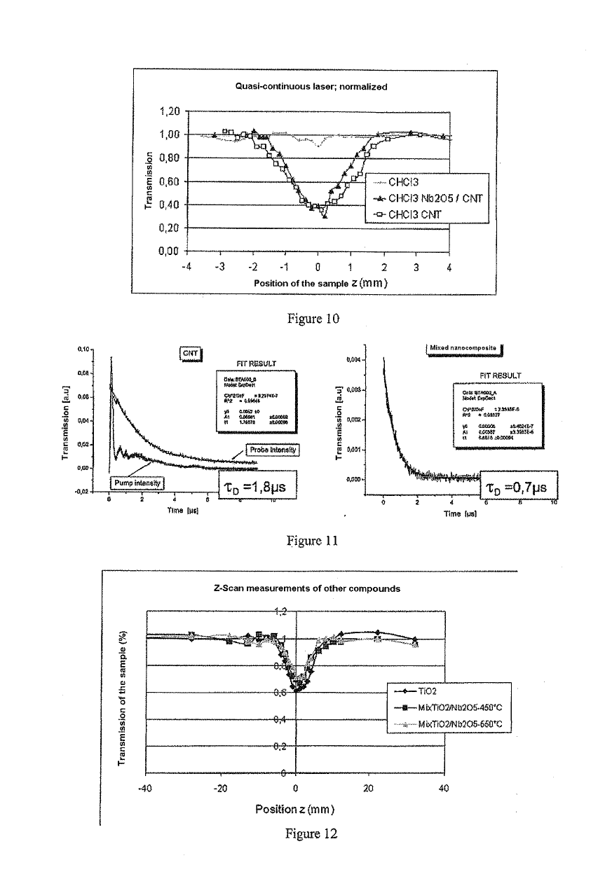

The results are presented in FIG. 10, which shows that the energy arriving on the detector (placed just behind the sample) is reduced by more than 60% with the suspension of nanocomposite of Example 1 or of CNTs, when compared with the energy arriving on the detector in the case of a sample containing only chloroform.

The appearance (FIG. 9) and stability of the suspension of nanocomposite of Example 1 (FIG. 8) are such that they allow it to be used as an optical limiter, in contrast with carbon nanotubes, the latter being of lower stability in suspension.

### Example 4: Study of the Switching Rate of the Nanocomposite of Example 1 (via the Pump-Probe Method)

FIG. 11 shows, firstly, the change in non-linear behaviour of the nanocomposite of Example 1 (shown in FIG. 3) suspended in chloroform, and, secondly, that of carbon nanotubes alone (not covered not filled, especially with niobium pentoxide). In this figure:
the solid-line curve corresponds to the time profile of the pulse of the pump laser, whereas
the dashed curve corresponds to the time signature of the non-linearities of the sample.

The switching times of the suspensions are obtained by linear regression of the curves and reflect the extinction rate of the optical limiting system. The measurements were taken just after ultrasonicating the suspensions. They show that the switching rate of the nanocomposite of Example 1 is much higher than that of the carbon nanotubes alone.

### Example 5: Preparation of an Example of a Nanocomposite According to the Invention Formed from Carbon Nanotubes Covered and/or Filled with TiO₂

The TiO₂/carbon nanotube nanocomposites are obtained by dispersing, by sonication, an amount of pulverulent carbon nanotubes (0.2 or 0.4 g) in a solution of ethanol (20 ml) for 1 hour, followed by addition, with slow stirring, of titanium isopropoxide (7 ml), the precursor for the sol-gel route synthesis.

The sol then obtained after addition of 2 M hydrochloric acid (12 ml), with vigorous stirring, is matured with stirring for 72 hours.

To finish, the milky solution thus obtained is then dried at room temperature for 24 hours, and then at 110° C. for 1 hour, before being calcined at 350° C. for 3 hours.

### Example 6: Characterization of the Nanocomposite of Example 5, in Terms of Morphology

### Characterization of the Morphology by TEM

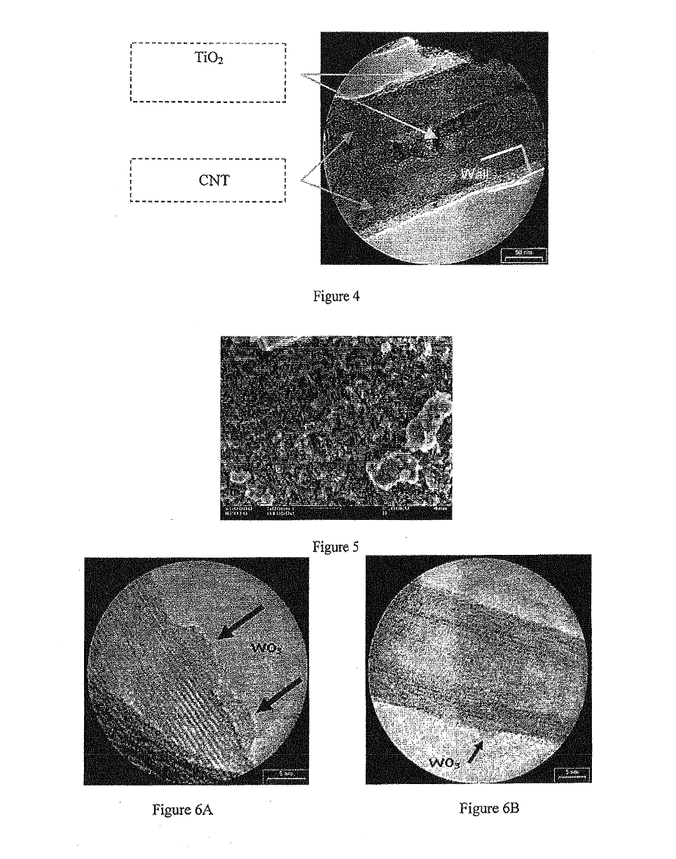

An image of the structure (or morphology) of the nanocomposite of Example 5 was obtained by high-resolution transmission electron microscopy (TEM) on the nanometric scale. This image presented in FIG. 4 shows that the nanocomposite of Example 5 is formed from carbon nanotubes covered and filled with titanium dioxide.

### Example 7: Preparation of a Nanocomposite According to the Invention Formed from TiO₂ Nanotubes Covered and/or filled with Niobium Pentoxide

A nanocomposite according to the invention based on powders of TiO₂ nanotubes and of niobium pentoxide (Nb₂O₅/TiO₂ nanotube powders) is prepared via the sol-gel route, using the same sol-gel method as in Example 1.

### Depilling/Deaggregation of the Bundles of TiO₂ Tubes

20 ml of absolute ethanol are mixed with 20 ml of acetic acid (these products are used without additional purification). The TiO₂ nanotubes are added to the mixture and ultrasonicated for one hour so as to separated the nanotubes.

Growth of the TiO₂ nanotubes (or titanate nanotubes) is performed via hydrothermal treatment at 130° C. of a TiO₂ powder in a concentrated (10 M) sodium hydroxide solution. Typically, 1 g of pulverulent TiO₂ (P25, Degussa) is added to 50 ml of an NaOH solution (10 M) in a Teflon autoclave; the whole is stirred for one hour and then left at 130° C. for 48 hours. The white powder obtained is then filtered off under vacuum and washed with HCl (2 M) until neutral, rinsed with distilled water then dried overnight at 110° C. A post-synthesis calcination treatment is performed at 380° C.

### Formation of the Amorphous Gel (Step a) of the Process of the Invention

1 ml of niobium ethoxide is added to the preceding solution, and the mixture thus obtained is ultrasonicated for one hour. Next, the whole is diluted with 20 ml of ethanol and the mixture is then left in the open air (for maturation) all day and all night so as to allow the formation of a sol, the evaporation of the solvent and the formation of the gel. A “dry” gel is then obtained, which is placed in an oven for 15 hours at 110° C. to remove the excess solvent.

### Milling of the Gel (Step c) of the Process of the Invention

The gel obtained is milled manually in a mortar using a pestle, and a cream-coloured powder is obtained.

### Calcination of the Milled Gel (Step d) of the Process of the Invention

After milling the gel, some of the powder obtained is placed in a calcination oven in order to obtain crystallization of the niobium pentoxide. The heat treatment performed therein is a calcination in air comprising a temperature increase ramp at 10° C/minute up to a temperature of 450° C., followed by maintenance at this temperature for 2 hours 45 minutes. At the end of calcination, a white powder formed from TiO₂ nanotubes that are covered and/or filled uniformly with niobium pentoxide nanoparticles is obtained.

The rest of the powder obtained is subjected to an air calcination treatment comprising a temperature increase ramp at 10° C/minute up to a temperature of 550° C., followed by maintenance at this temperature for 2 hours 45 minutes. At the end of calcination, a white powder formed from TiO₂ nanotubes that are uniformly covered and/or filled with niobium pentoxide nanoparticles is also obtained.

Crystallization of the niobium pentoxide takes place above 520° C., and the calcination temperatures were chosen so as to scan a temperature range extending from the degradation of the morphology of the TiO₂ nanotubes and the crystallization of the Nb₂O₅.

The two powders of nanocomposite thus obtained are then characterized by laser granulometry (measurement of the size of the grains of the powder obtained) and by high-resolution transmission electron microscopy (morphology of the nanotubes). Next, a study is made via optical measurements of the non-linear behaviour (via the Z-scan technique) of these powders, and also their switching rate (via the pump-probe method).

### Example 8: Characterization of the Morphology of the Nanocomposite of Example 7 (by SEM)

An image of the morphology of the nanocomposite of Example 7 (obtained by calcination at 450° C.) was obtained by scanning electron microscopy. This morphology is presented in FIG. 5. The presence of TiO₂ nanotubes 100 nm long is observed, the particles that are not one-dimensional being Nb₂O₅ particles.

### Example 9: Study of the Non-Linear Behaviour of the Nanocomposite of Example 7 (via the Z-SCAN Method)

The two nanocomposites of Example 7 (powder calcined at 450° C., on the one hand, and powder calcined at 550° C., on the other hand) are suspended in chloroform at a rate of 3 mg of powder per 20 g of solvent. For comparison, titanium dioxide nanotubes that are neither filled nor covered with niobium pentoxide are also suspended in chloroform.

Next, their non-linear behaviour is studied using the Z-SCAN method, the operating principle of which is illustrated by FIG. 1.

The results, which are presented in FIG. 12, show that the energy arriving on the detector (placed just behind the sample) is reduced by 30% to 40% with the three suspensions.

This shows that the Nb₂O₅/TiO₂ nanotube nanocomposites do indeed show non-linear behaviour that is clearly reflected by a drop in transmission, but which is, however, less than that observed with the Nb₂O₅/CNTs nanocomposite.

### Example 10: Study of the Switching Rate of the Nanocomposite of Example 7 (via the Pump-Probe Method)

The two nanocomposites of Example 7 (powder calcined at 450° C., on the one hand, and powder calcined at 550° C., on the other hand) are suspended in chloroform in a proportion of 3 mg of powder per 20 g of solvent. For comparison, titanium dioxide nanotubes that are not filled and not covered with niobium pentoxide are also suspended in chloroform. Next, their switching rate is determined (by means of the pump-probe method, the operating principle of which is illustrated by the figure in FIG. 2):
just after placing them in suspension (t₀), and
at various time intervals after placing them in suspension (t₀+42 hours and t₀+66 hours) so as to evaluate the stability of the material in suspension.

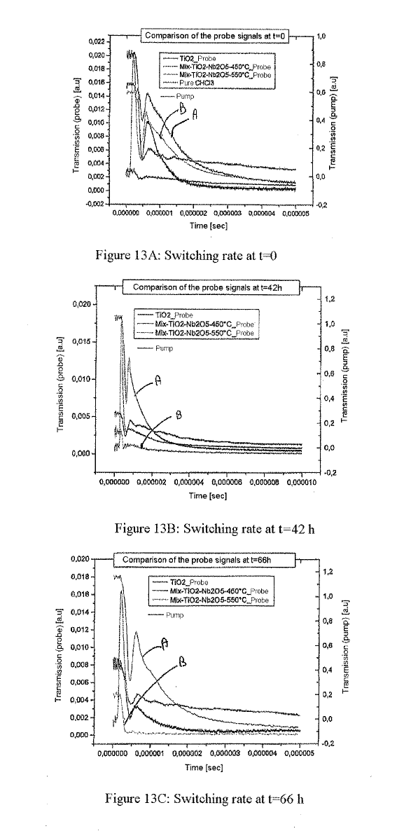

The results obtained just after suspending the samples are presented in FIG. 13A. These results show a high switching rate for the nanocomposites of the invention, and a very low switching rate for the TiO₂ nanotubes alone.

The results obtained at t₀+42 hours are presented in FIG. 13B. These results show that 42 hours after being placed in suspension, the Nb₂O₅/TiO₂ nanotube nanocomposite calcined at 450° C. is stable (curve A): the shape of the curve is identical to that obtained at t₀. On the other hand, the Nb₂O₅/TiO₂ nanotube nanocomposite calcined at 550° C. (curve B), although having a smaller drop in transmission, no longer shows any solvent effect (boiling), which is reflected by the appearance of the “bounce” on the curve. The switching in this case is more efficient.

These results show that the calcination temperature of a material has an influence on the stability in suspension and also on the switching efficacy: the nanocomposite according to the invention, Nb₂O₅/TiO₂ nanotubes calcined at 450° C., shows higher stability than the nanocomposite according to the invention, Nb₂O₅/TiO₂ nanotubes calcined at 550° C.

However, the nanocomposite according to the invention, Nb₂O₅/TiO₂ nanotubes calcined at 550° C., has a much shorter switching time than the nanocomposite according to the invention, Nb₂O₅/TiO₂ nanotubes calcined at 450° C. Moreover, an XRD measurement performed on this material shows that at 550° C., it is crystalline, whereas at 450° C. it is still amorphous. The suspension stability thus appears to be linked to the degree of crystallization of the nanocomposite.

The results at t₀+66 hours are presented in FIG. 13C. These results show results similar to those obtained 42 hours after placing the nanocomposites in suspension. They especially confirm that the calcination temperature of the nanomaterials is thus an essential parameter for the stability of the materials in suspension and for their optical response.

### Example 11: Preparation of an Example of a Nanocomposite According to the Invention Formed from TiO₂ Nanotubes Covered and Filled with WO₃

The TiO₂ (or titanate) nanotubes synthesized are then impregnated with an ethanol/deionized water solution (⅓) containing a tungsten salt, (NH₄) 10W₁₂O₄₁·5H₂O. After stirring for 1 hour, the mixture is sonicated for 1 hour, followed by evaporation at room temperature for 24 hours with stirring. The powder thus obtained is then dried at 110° C. overnight.

### Example 12

Two images of the structure (morphology) of the nanocomposite of Example 11 were obtained by high-resolution transmission electron microscopy (TEM).

These images, represented respectively by FIGS. 6A and 6B, show that the nanocomposite of Example 11 is formed from TiO₂ nanotubes filled and covered with WO₃.

### Example 13: Preparation of an Example of a Nanocomposite of the Invention Formed from Carbon Nanofibres Covered and Filled with Nb₂O₅

10 ml of absolute ethanol (CH₃CH₂OH) are mixed with 10 ml of acetic acid (CH₃COOH). The solvents were purchased from Fluka and Aldrich and used without additional purification. 0.036 g of carbon nanofibres, synthesized in the laboratory by the present Applicant company, are added to the mixture and ultrasonicated for one hour. The aim of this step is to deaggregate the carbon nanofibres as much as possible. The solution obtained is black.

The details of the synthesis of carbon nanofibres are given below:

The carbon nanofibres are synthesized by catalytic decomposition of a reaction mixture of ethane and hydrogen with nickel particles supported on a graphite felt serving as macroscopic support:
the graphite felt support produced by the company Carbone Lorraine Co. is composed of a network of graphite microfibres with an outside diameter centred about 15 μm, a length of several micrometres and a specific surface area measured by the BET method of 1 m².g⁻¹,
the precursor salt used is a transition metal nitrate: Ni (Fluka, nickel (II) nitrate hexahydrate 98%). An aqueous 20% ethanol solution containing the precursor salt is prepared and is then deposited dropwise onto the surface of the felt. This impregnation of the pore volume is performed respecting the volume absorbed by the material. The metal charge is set at 1% by mass relative to the mass of the support.

The support prepared is dried at room temperature in air for 12 hours, and then calcined at 400° C. for 2 hours in a Pyrex tube under a stream of air (20 cm³/min) so as to convert the metal nitrate into oxide. The heating is performed at a rate of 20° C./minute.

The metal oxide supported on carbon felt thus obtained is reduced in situ at 400° C. under a stream of H₂ (20 cm³/min) for 1 hour. The temperature is then increased from 400 to 750° C. (20° C./min) and the stream of H₂ is replaced with the C₂H₆/H₂ reaction mixture (60/40).

0.5 ml of niobium ethoxide (Nb(OEt)₅) purchased from Sigma Aldrich, 99.95%, is added and the mixture is ultrasonicated for one hour. Next, the whole is diluted with 10 ml of ethanol. The mixture is left in the open air (maturation) all day so as to allow the formation of the sol, the evaporation of the solvent and the formation of the gel. The dry gel is placed in an oven for 15 hours at 120° C. to remove the excess solvent. After milling the gel, the powder obtained is placed in a calcination oven so as to obtain the crystallization of Nb₂O₅.

100 mg of powder are calcined in a calcination oven at 450° C. The ramp is 10° C./minute, the final temperature is 450° C. and the sample is calcined in air for 2 hours 45 minutes. At the outlet, the powder obtained is black.

100 mg of powder are calcined in a calcination oven at 520° C. The ramp is 10° C./minute, the final temperature is 520° C. and the sample is calcined in air for 2 hours 45 minutes. At the outlet, the powder obtained is grey. The powder begins to crystallize at and above 520° C.

### Example 14: Characterization of the Nanocomposite of Example 13 in Terms of Morphology

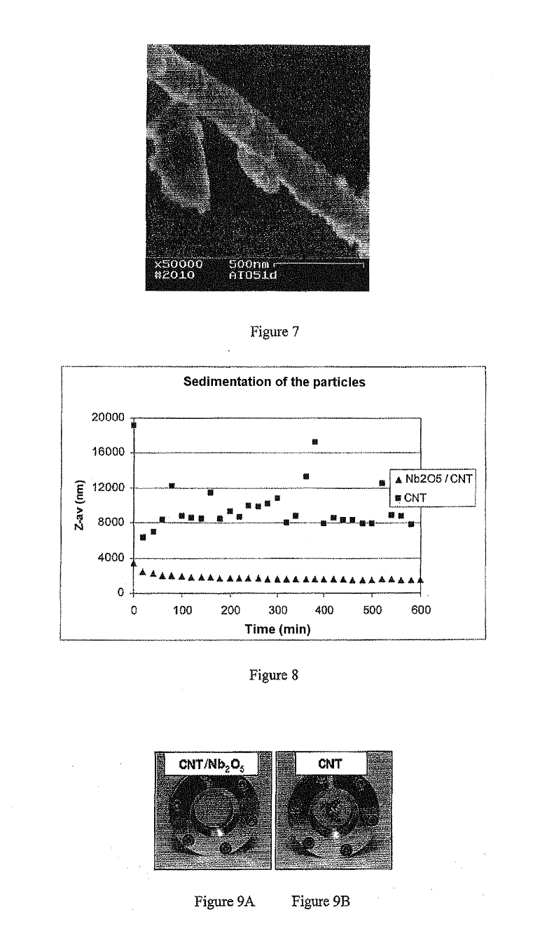

The nanocomposite of Example 13 is presented in FIG. 7 obtained by scanning microscopy. A carbon nanofibre with a diameter of 200 nm covered with Nb₂O₅ nanoparticles is seen therein.

### LIST OF REFERENCES

[1] FR 2 787 203

[2] “Single-wall carbon nanotubes for optical limiting” by L. Vivien, E. Anglaret, D. Riehl, F. Bacou, C. Journet, C. Goze, M. Andrieux, M. Brunet, F. Lafonte, P. Bernier and F. Hache, in “Chemicals Physics Letters” 307 (1999) 317-319,

[3] “Optical limiting properties of single-wall carbon nanotubes” by L. Vivien, E. Anglaret, D. Riehl, F. Hache, F. Bacou, M. Andrieux, F. Lafonte, C. Journet, C. Goze, M. Brunet, and P. Bernier, in “Optical Communications” 174 (2000) 271-275,

[4] “Optical limiting properties of carbon nanotubes” by L. Vivien, D. Riehl, F. Hache, and E. Anglaret, in “Physical B” B 323 (2002) 233-234,

[5] “Two methods of obtaining sol-gel Nb2O5 thin films for electrochromic devices”, C. O. Avellaneda, A. Pawlicka and M. A. Aegerter, Journal of Material Science 33 (1998) 2181-2185,

[6] “Sol-gel synthesis and characterization of Nb2O5 powders”, M. Ristic, S. Popovic and S. Music, Materials Letters 58 (2004) 2658-2663.

1. Nanocomposite, characterized in that it comprises single-wall and/or multi-wall one-dimensional nanomaterials, and at least one nanooxide of at least one transition metal, said nanooxide filling said nanotubes and/or covering their walls.

2. Nanocomposite according to claim 1, in which the one-dimensional nanomaterials are formed from a heat-conducting and/or electrically conducting and/or ion-conducting material.

3. Nanocomposite according to claim 1, in which the nanotubes are carbon nanotubes (CNTs).

4. Nanocomposite according to claim 1, in which the nanooxide is Nb₂O₅.

5. Optical limiting and protecting device, characterized in that it comprises a nanocomposite as defined according to claim 1 suspended in a medium that is transparent to visible and infrared radiation.

6. Device according to claim 5, wherein said medium that is transparent to visible and infrared radiation is a liquid medium.

7. Device according to claim 6, wherein said liquid medium is CHCl₃ or CS₂.

8. Device according to claim 5 which may comprise one or more surfactants or dispersants.

9. Process for preparing a nanocomposite, characterized in that it comprises single-wall and/or multi-wall one-dimensional nanomaterials, and at least one nanooxide of at least one transition metal, said nanooxide filling said nanotubes and/or covering their walls, characterized in that it comprises the following steps:
a) either a step of formation via the sol-gel route of a gel from a mixture:
of an alcoholic solution containing at least one alkoxide or a transition metal chloride, and
single-wall or multi-wall one-dimensional nanomaterials, said gel in formation being in amorphous form;
b) or a step of impregnating a salt containing at least one transition metal precursor;
c) optionally, a step of milling the gel obtained in step a); and
d) a step of calcination of said optionally milled gel at a temperature and for a time corresponding to a more or less partial crystallization of the transition metal nanooxide inside said nanotubes and/or on their walls, while conserving at least partially the one-dimensional nature of the nanotubes.

10. Process according to claim 9, characterized in that, in step a) of formation via the sol-gel route of a gel, the transition metal alkoxide is chosen from niobium ethoxide Nb(OEt)₅ or titanium tetraisopropoxide Ti(OiPr)₄.

11. Process according to claim 9, characterized in that, in step b) of impregnation, the salt containing at least one precursor of a transition metal is ammonium paratungstate (NH₄)₁₀W₁₂O₄₁.

12. Process according to claim 9, characterized in that the calcination temperature is between 150 and 550° C.

13. Process according to claim 12, characterized in that, when the nanocomposite to be prepared comprises carbon nanotubes covered and/or filled with niobium pentoxide, the calcination temperature is between 450° C. and 530° C.

14. Process according to claim 12, characterized in that, when the nanocomposite to be prepared comprises TiO₂ nanotubes covered and/or filled with niobium pentoxide, the calcination temperature is between 150° C. and 550° C.

15. Process according to claim 9, also comprising, prior to step a) of formation of the gel, a step of ultrasonication treatment of the nanotubes.

16. Process according to claim 9, also comprising, subsequent to step a) of formation of the gel, or to step b) of impregnation, a step of heat treatment at a temperature that allows the excess solvent to be removed.

17. Method for protecting an optical and/or optronic device against electromagnetic waves with wavelengths ranging from the visible to the medium infrared range using an optical limiting device according to claim 5.

18. Method according to claim 17, characterized in that said optical and/or optronic device is an optical switch.
